(19) United States
(12) Patent Application Publication
(10) Pub. No.: US 2005/0193523 A1
(43) Pub. Date: Sep. 8, 2005

(54) Hinge device for storage container and storage container having the same

(75) Inventors: Jeong Man Nam, Gwangju-City (KR); Ji Man Kim, Gwangju-City (KR); Yong Myoung Kim, Gyeonggi-Do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/068,987

(22) Filed: Mar. 2, 2005

(30) Foreign Application Priority Data
Mar. 5, 2004 (KR) 2004-15187
Aug. 20, 2004 (KR) 2004-65961

(51) Int. Cl. E05F 3/20

(52) U.S. Cl. 16/330

(57) ABSTRACT

A hinge device for a storage container which includes a pair of hinge couplers combined in the form of a single unit, and enables a door of the storage container to be more smoothly closed without generating impact. A storage container, which includes the hinge device, is also disclosed. The hinge device includes a housing fixed to a container body of the storage container or the door, a first hinge shaft and a second hinge shaft rotatably coupled to the housing at opposite sides of the housing, respectively, each of the first and second hinge shafts having one end extending into the housing, and the other end extending outwardly beyond the housing and fixedly coupled to the other one of the container body and the door, a driver arranged in the housing at the side of the first hinge shaft to apply, to the first hinge shaft, a rotating force to cause the door to be maintained in an opened state or to be closed in accordance with an opening angle of the door, and a damper arranged in the housing at the side of the second hinge shaft to increase a resistance to rotation of the second hinge shaft, and thus, to cause the door to be smoothly closed.

This application claims priority from Korean Patent Applications No. 2004-15187 and 2004-65961, respectively filed on Mar. 5, 2004 and Aug. 20, 2004 in the Korean Intellectual Property Office, the disclosures of which are incorporated herein by reference.

### BACKGROUND OF THE INVENTION

1. Field of the Invention

The present invention relates to a hinge device for a storage container, which hingably couples a door to a body of the storage container, and a storage container, which has the hinge device. More particularly, the present invention relates to a hinge device for a storage container, which hingably couples a door to a body of the storage container, using a simple configuration, and enables the door to be more smoothly closed, and a storage container, which has the hinge device.

2. Description of the Related Art

In general, as a top opening-type storage container, a typical Kimchi storage container is known, which has an upwardly-opened container body and a cover attached to the top of the container body to hingably open and close the top of the container body. The container body is defined with an upwardly-opened storage compartment. A hinge device is arranged between the container body and the door to couple the container body and door such that the door is hingable with respect to the container body.

Typically, the hinge device includes a cylindrical housing fixed to the top of the container body for coupling of a rear end of the door to the container body, and a pair of hinge units respectively mounted to opposite ends of the housing in a state of being received in the housing, to hingably couple opposite portions of the rear end of the door to the opposite ends of the housing. Each hinge unit includes a shaft extending outwardly from the associated end of the housing such that the shaft is coupled with the associated portion of the rear end of the door.

However, the hinge device uses an increased number of constituent elements because two hinge units are prepared, separately from the housing fixed to the container body, and are mounted to the housing in a state of being received in the opposite end portions of the housing. For this reason, the hinge device involves an increase in manufacturing costs and a difficult assembling process. Furthermore, there is a problem in that high impact may be generated when the door is closed because the hinge device has an insufficient buffering function in spite of the fact that the door is more or less heavy.

### SUMMARY OF THE INVENTION

The present invention has been made in view of the above-mentioned problems, and an aspect of the invention is to provide a hinge device for a storage container which includes a pair of hinge couplers combined in the form of a single unit, so that the hinge device has a simple configuration, and enables a door of the storage container to be more smoothly closed, and a storage container, which has the hinge device.

In accordance with one aspect, the present invention provides a hinge device for a storage container adapted to hingably connect a container body of the storage container and a door of the storage container. The hinge device has a housing fixed to one of the container body and the door, a first hinge shaft and a second hinge shaft rotatably coupled to the housing at opposite sides of the housing, respectively. Each of the first and second hinge shafts have one end extending into the housing, and the other end extending outwardly beyond the housing and fixedly coupled to the other one of the container body and the door. A cam hinge part having a cam shaft section provided at a portion of the first hinge shaft is arranged in the housing to form a first cam. A movable member is formed with a second cam arranged to face the first cam, and an elastic member is provided to press the movable member. Further, a damper is provided at the second hinge shaft to increase a rotational resistance of the door.

The damper may have a damping case, in which a fluid chamber to contain a predetermined viscous fluid is defined, a damping shaft inserted into the damping case, and at least one vane provided at a peripheral surface of the damping shaft to rotate together with the damping shaft, and arranged in the fluid chamber.

The vane may have a fluid passage having a predetermined size.

The damper may increase the rotational resistance of the door when the door reaches approximately a position where the door is completely closed.

The damper may further have a damping boosting portion. The damping booster portion can be provided at a portion of an inner peripheral surface of the damping case at the side of the fluid chamber, which faces the vane when the door reaches approximately a position where the door is completely closed. The damping boosting portion reduces a gap defined between the inner peripheral surface of the damping case and the vane when the door reaches approximately the position where the door is completely closed.

The damping boosting portion may come into close contact with the vane when the door reaches approximately the position where the door is completely closed.

The damping boosting portion may be radially inwardly protruded from the inner peripheral surface of the damping case in the form of a protrusion.

The vane may have a first body provided at the peripheral surface of the damping shaft, integrally with the damping shaft, and a second body arranged between the inner peripheral surface of the damping case and the first body, and coupled to the first body, the second body being made of an elastic material.

The damping shaft may be integrated with the second hinge shaft.

The damping shaft may be coupled to the second hinge shaft.

The damper may further have a spring to force the damping case to move toward the second hinge shaft.

The damping shaft may include an insert section inserted into the damping case, and an extension extending outwardly beyond the damping case. The damping case may have an opening formed at one end of the damping case to allow the insert section of the damping shaft to be inserted into the damping case. The insert section of the damping shaft has a portion arranged in the fluid chamber to install the vane on the insert section portion.

The insert section may include a first insert section portion arranged in the fluid chamber and provided with an end axially supported by an inner end surface of the damping case opposite to the opening, and a second insert section portion arranged between the extension and the first insert section portion. The damping shaft may further include a first seal portion extending radially outwardly from the second insert section portion at a position adjacent to the first insert section portion, such that the first seal portion comes into contact with the inner peripheral surface of the damping case to prevent the fluid in the fluid chamber from being leaked through the opening.

The damper may further have an annular cover fitted between the inner peripheral surface of the damping case and a peripheral surface of the second insert section portion at the side of the opening, to close the opening. At least one first sealing member can be fitted around the peripheral surface of the second insert section portion between the first seal portion and the cover, and a seal fitting portion arranged at the second insert section portion extending axially from an end of the first seal portion facing the opening and toward the opening. The seal fitting portion has a diameter smaller than a diameter of the first seal portion, but larger than a diameter of the second insert section portion at the side of the cover. A first axial support bush is fitted between the cover and the second insert section portion to rotatably support the damping shaft. A second seal portion extends radially from an end of the first axial support bush between the cover and the seal fitting portion such that the second seal portion comes into contact with the inner peripheral surface of the damping case, and at least one pressing washer fitted around the seal fitting portion is provided. An end of the damping case, defining the opening, may be radially inwardly bent to engage with the cover, and thus, to support the cover, so that the damping shaft is fixed in the damping case. The second seal portion comes into contact with an end of the seal fitting portion facing the opening when the damping shaft is fixed in the damping case. The first sealing member is pressed and elastically deformed between the first seal portion and the second seal portion when the damping shaft is fixed in the damping case. The at least one pressing washer is pressed between the first seal portion and the second seal portion to elastically deform the first sealing member.

The thickness sum of the at least one first sealing member and the at least one pressing washer, before the at least one first sealing member is elastically deformed, may be larger than the length of the seal fitting portion.

The at least one pressing washer may have a pair of pressing washers respectively arranged at opposite sides of the first sealing member.

The damper may further have a diameter-reduced axial support protruded from an end of the first insert section portion opposite to the opening, a fitting groove formed at an inner end surface of the damping case opposite to the opening, to receive the axial support, and a second axial support bush fitted between the axial support and the fitting groove.

The damper may further have a fluid injection port formed through a portion of the damping case at the side of the fluid chamber, to inject the fluid into the fluid chamber, the fluid injection port being closed by a screw fastened to the fluid injection port in a state in which a second sealing member is interposed between the fluid injection port and the screw.

The damper may further have a diameter-reduced axial support protruded from an end of the first insert section portion opposite to the opening, a fitting groove formed at an inner end surface of the damping case opposite to the opening, to receive the axial support. The fitting groove communicates with the fluid injection port. Further, a second axial support bush is fitted between the axial support and the fitting groove. A first communication hole and a second communication hole, respectively formed between the axial support and the second axial support bush, and between the inner end surface of the damping case opposite to the opening and an end surface of the insert section around the axial support, are provided to communicate the fluid injection port with the fluid chamber.

The damping case may be arranged in the housing such that the damping case is prevented from rotating.

The first and second cams may have cam surfaces having a valley-and-mountain structure such that the cam surfaces are engaged with each other, respectively. Each of the cam surfaces may have an inclined opening guide surface and a substantially horizontal closing guide surface.

The housing may have a housing body having opened opposite ends to receive the cam hinge part and the damper, respectively, and a pair of covers respectively fitted in the opened opposite ends of the housing body, and centrally formed with shaft fitting holes, through which the first and second hinge shafts extend.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings in which:

FIG. 1 is an exploded perspective view of a Kimchi storage container, to which a hinge device consistent with the present invention is applied, illustrating an outer structure and a door mounting structure of the Kimchi storage container;

FIG. 2 is a sectional view of the Kimchi storage container, illustrating the door mounting structure and an inner configuration of the Kimchi storage container;

FIG. 3 is a perspective view illustrating a configuration of the storage container hinge device consistent with the present invention;

FIG. 4 is an assembled perspective view of the storage container hinge device consistent with the present invention, illustrating operations of a driver and a first hinge shaft when a door is opened;

FIG. 5 is an assembled perspective view of the storage container hinge device consistent with the present invention, illustrating operations of the driver and first hinge shaft when the door is closed;

FIG. 6 is a perspective view illustrating a movable member included in the storage container hinge device consistent with the present invention;

FIG. 7 is a schematic view of first and second cams included in the storage container hinge device consistent with the present invention, illustrating the conditions of the first and second cams when the door is opened;

FIG. 8 is a schematic view of the first and second cams included in the storage container hinge device consistent with the present invention, illustrating the conditions of the first and second cams when the door is closed;

FIG. 9 is a perspective view of the storage container hinge device consistent with the present invention, illustrating a damper and a second hinge shaft, which are separated from each other.

FIG. 10 is a sectional view illustrating the condition of the storage container hinge device consistent with the present invention prior to fixing of a damping shaft in a damping case;

FIG. 11 is a sectional view illustrating the condition of the storage container hinge device consistent with the present invention after fixing of the damping shaft in the damping case;

FIG. 12 is an enlarged sectional view illustrating arrangement of a first sealing member and pressing washers consistent with the present invention;

FIG. 13 is a partially-broken perspective view of a fluid injection structure consistent with the present invention, illustrating the condition in which the damping shaft is fixed in the damping case;

FIG. 14 is a perspective view illustrating a structure of the damping shaft;

FIG. 15 is a sectional view illustrating the condition in which a fluid injection portion is closed after injection of a fluid into a fluid chamber defined in the damping case in a state of FIG. 11;

FIG. 16 is an exploded perspective view illustrating a rotation preventing structure of the damping case consistent with the present invention;

FIG. 17 is a perspective view illustrating structures of the damping shaft and damping case; and

FIGS. 18 and 19 are sectional views taken along a line A-A of FIG. 17, illustrating operation of vanes consistent with a hinging operation of the door.

### DETAILED DESCRIPTION OF THE ILLUSTRATIVE, NON-LIMITING EMBODIMENTS

Reference will now be made in detail to illustrative, non-limiting embodiments of the present invention, examples of which are illustrated in the accompanying drawings. The embodiments are described below to explain the present invention by referring to the accompanying figures.

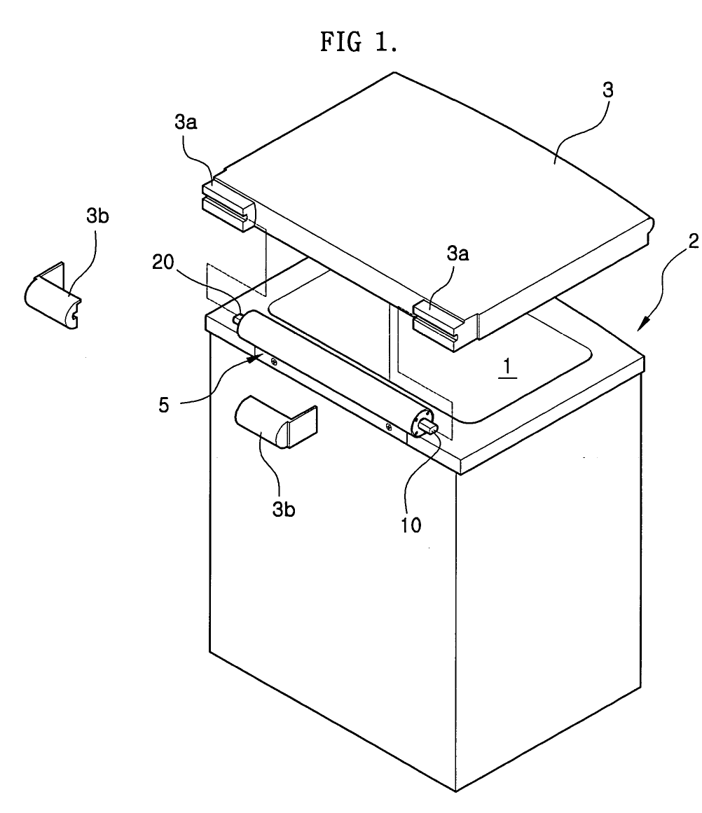

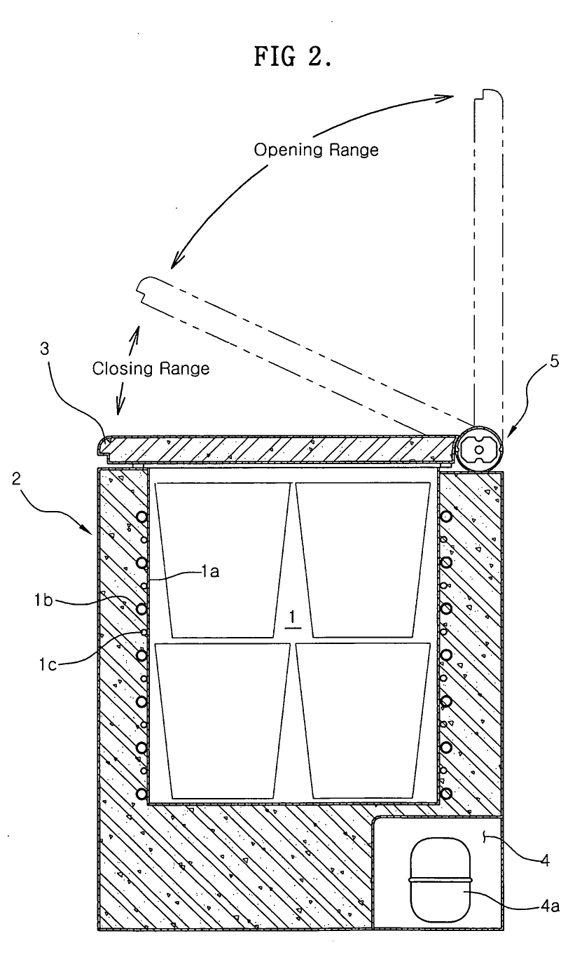

FIG. 1 is an exploded perspective view illustrating a Kimchi storage container, to which a hinge device consistent with the present invention is applied. FIG. 2 is a sectional view of the Kimchi storage container. As shown in FIGS. 1 and 2, the Kimchi storage container includes a container body 2 made of a thermal insulating material and defined therein with an upwardly-opened storage compartment 1, and a door 3 hingably coupled to the top of the container body 2 to open and close the top of the storage compartment 1.

An evaporator 1b, which consists of a typical refrigerant tube, is arranged on an outer surface of an inner container wall 1a defining the storage compartment 1, to cool the storage compartment 1. A heater 1c, which consists of a typical electric heating wire, is also arranged on the outer surface of the inner container wall 1a, to, for example, ferment Kimchi. A machinery compartment 4, which is separate from the storage compartment 1, is formed in a lower portion of the container body 2 at one side of the container body 2, to receive a compressor 4a, etc.

The hingable coupling of the door 3 to the top of the container body 2 is achieved at a rear end of the door 3 by a hinge device 5. The hinge device 5 is fixed to the top of the container body 2 at a rear side of the container body 2. The hinge device 5 includes a housing fixed to the top of the container body 2 at the rear side of the container body 2, and a pair of hinge shafts 10 and 20 arranged at opposite ends of the housing such that the hinge shafts 10 and 20 are rotatable. Coupling members 3a are provided at the rear end of the door 3 at opposite sides of the door 3 so that the coupling members 3a are coupled with the hinge shafts 10 and 20, respectively. A cover member 3b is fitted around each coupling member 3a such that an associated one of the hinge shafts 10 and 20 is fitted between the coupling member 3a and the cover member 3b. As a result, the hinge shafts 10 and 20 are maintained in a fixed state with respect to the associated coupling members 3a and cover members 3b. Thus, the door 3 is hingably coupled to the container body 2.

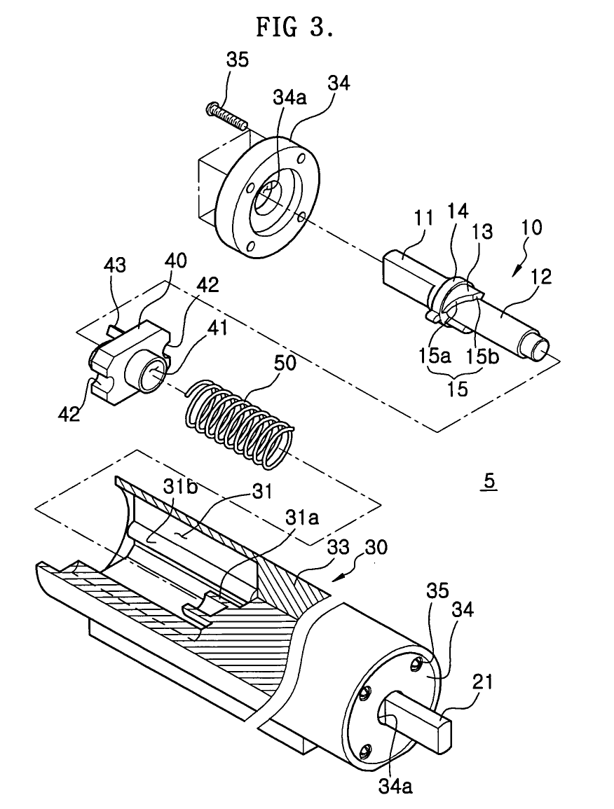

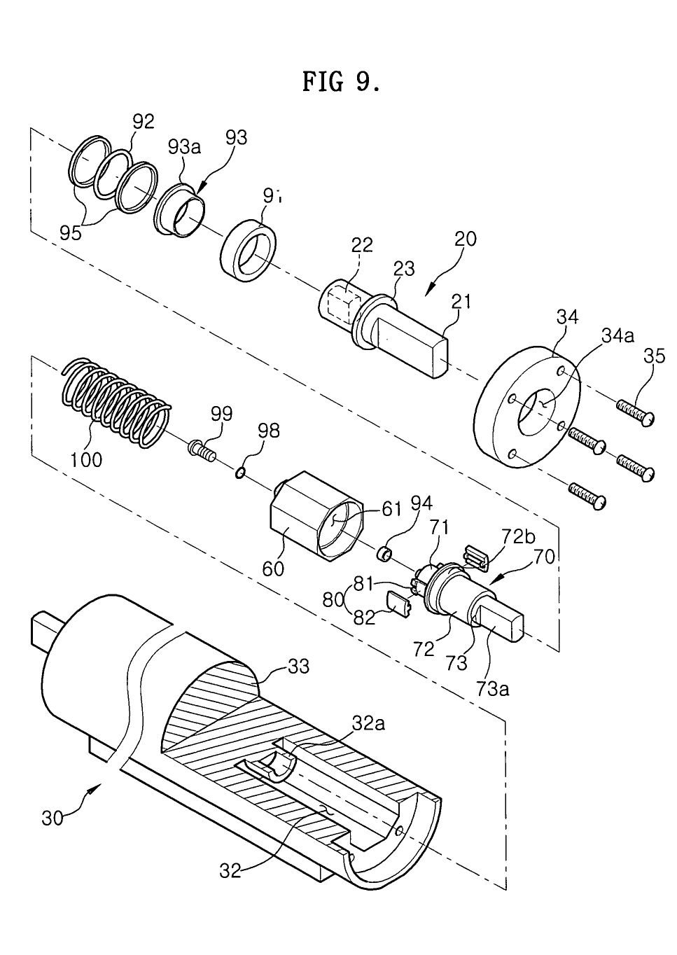

In FIGS. 3 and 9, the housing, which is included in the hinge device 5, is designated by reference numeral 30. The hinge shafts 10 and 20 are rotatably coupled with the opposite ends of the housing 30, respectively. Each of the hinge shafts 10 and 20 has an inner end extending inwardly into the housing 30 and an outer end extending outwardly from the housing 30. The hinge shafts 10 and 20 are provided, at respective outer ends thereof, with door coupling sections 11 and 21 to be coupled with the coupling members 3a of the door 3. In the following description, the hinge shafts 10 and 20 are also referred to as first and second hinge shafts.

The hinge device 5 also includes a driver (described in detail later) arranged in one end portion of the housing 30 at the side of the first hinge shaft 10 to apply, to the first hinge shaft 10, a rotating force to cause the door 3 to be maintained in an opened state or to be closed in accordance with an opening angle of the door 3. The hinge device 5 further includes a damper (described in detail later) arranged in the other end portion of the housing 30 at the side of the second hinge shaft 20 to increase a resistance to rotation of the second hinge shaft 20, and thus, to cause the door 3 to be smoothly closed.

The housing 30 includes a housing body 33 opened at opposite ends thereof, and defined with first and second receiving spaces 31 and 32 to receive the driver and damper at the sides of the hinge shafts 10 and 20, respectively, and a pair of covers 34 respectively fitted in the opened opposite ends of the housing body 33 to close the opened opposite ends of the housing body 33, and centrally formed with shaft fitting holes 34a, through which the door coupling sections 11 and 21 of the hinge shafts 10 and 20 extend, respectively. Each cover 34 is fixedly mounted to the associated end of the housing body 33 by means of screws 35.

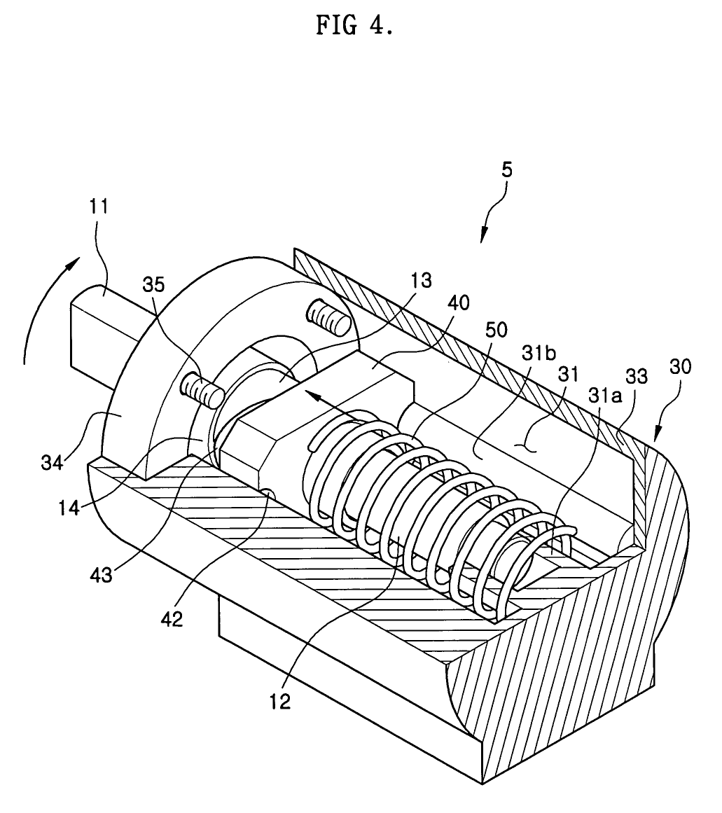

Detailed structures of the first hinge shaft 10 and driver will be described hereinafter. As shown in FIGS. 3 to 5, a cam shaft section 12 is provided at the inner end of the first hinge shaft 10 extending inwardly into the housing 30. A first cam 13 is formed on a peripheral surface of the cam shaft section 12. The driver includes a movable member 40 fitted around the peripheral surface of the cam shaft section 12 such that the movable member 40 is axially movable along the cam shaft section 12, while being prevented from rotating about the cam shaft section 12, and a spring 50 fitted around the cam shaft section 12 to continuously force the movable member 40 to move toward the first cam 13. The movable member 40 is provided with a second cam 43 facing the first cam 13 such that the second cam 43 is in contact with the first cam 13 by virtue of the elasticity of the spring 50. A first inner support 31a is formed at a portion of the housing 30 defining an inner end of the first receiving chamber 31, to rotatably support the inner end of the first hinge shaft 10 and to support the spring 50. A support rim 14 is formed on a portion of the first hinge shaft 10 adjacent to the first cam 13. The support rim 14 is abutted on an inner surface of the cover 34 around the shaft fitting hole 34a, through which the first hinge shaft 10 extends.

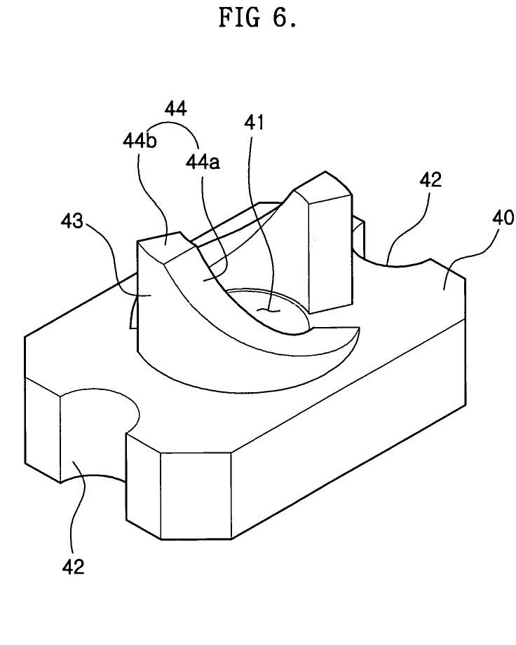

As shown in FIGS. 3 and 6, the movable member 40 has a shape corresponding to the shape of an inner peripheral surface of the housing body 33 at the side of the first receiving space 31, so that the movable member 40 is movable along the inner peripheral surface of the housing body 33. The movable member 40 also has a central through hole 41 so that the movable member 40 is fittable around the cam shaft section 12 of the first hinge shaft 10. Elongated guide rails 31b are formed on the inner peripheral surface of the housing body 33 such that the guide rails 31b extend in the axial direction of the first hinge shaft 10. The guide rails 31b guide the movable member 40 to move smoothly along the first hinge shaft 10 in a state of being prevented from rotating. The movable member 40 is also provided with guide grooves 42 engaged with the guide rails 31b.

The second cam 43 is formed at a surface of the movable member 40 facing the first cam 13, integrally with the movable member 40. The second cam 43 has a cam surface 44 to come into contact with a cam surface 15 provided at the first cam 13. The second cam 43 causes the first hinge shaft 10 to be rotated in accordance with movement of the movable member 40, in cooperation with the first cam 13. The spring 50 is arranged to continuously force the movable member 40 toward the first cam 13, in a state of being fitted around the cam shaft section 12 of the first hinge shaft 10 positioned in the first receiving space 31. In accordance with this structure, the cam surface 44 of the second cam 43, provided at the movable member 40, is always pressed against the cam surface 15 of the first cam 13 provided at the cam shaft section 12.

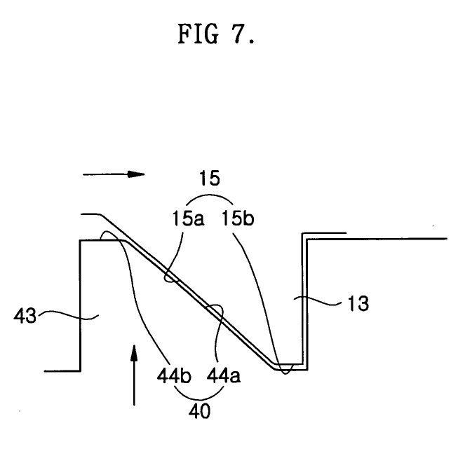

As shown in FIGS. 6 to 8, the cam surfaces 15 and 44 of the first and second cams 13 and 43 have a valley-and-mountain structure so that they are engaged with each other. Respective cam surfaces 15 and 44 have opening guide surface portions 15a and 44a each having an inclined spiral shape with a predetermined length to cause the first hinge shaft 10 to generate a rotating force in an opening direction of the door 3, in accordance with the elasticity of the spring 50 applied to the movable member 40 when the door 3 is opened through a predetermined angle or more. As the rotating force in the opening direction of the door 3 is applied to the movable member 40 when the door 3 is opened through the predetermined angle or more, it is possible to maintain the door 3 in the opened state without being closed due to the weight of the door 3.

Respective cam surfaces 15 and 44 also have closing guide surface portions 15b and 44b each having a flat shape extending in the rotating direction of the first hinge shaft 10a, and a predetermined length, to cause the first hinge shaft 10 to generate a rotating force in an opening direction of the door 3 in accordance with the elasticity of the spring 50 applied to the movable member 40 when the door 3 is opened through a predetermined angle or more. As the rotating force in the opening direction of the door 3 is applied to the movable member 40 when the door 3 is opened through the predetermined angle or more, it is possible to maintain the door 3 in the opened state without being closed due to the weight of the door 3. Under the condition in which the closing guide surfaces 15b and 44b of the first and second cams 13 and 43 are in contact with each other, the elasticity of the spring 50 cannot effect the rotation of the first hinge shaft 10, so that the door 3 is automatically closed by the weight thereof.

Although not shown, the cam surfaces 15 and 44 may dispense with the closing guide surface portions 15b and 44b. In this case, the door 3 can be closed by the weight thereof under the condition in which the end of the opening guide surface 15a, at the side of the closing guide surface 15b, and the end of the opening guide surface 44a, at the side of the closing guide surface 44b, are in contact with each other.

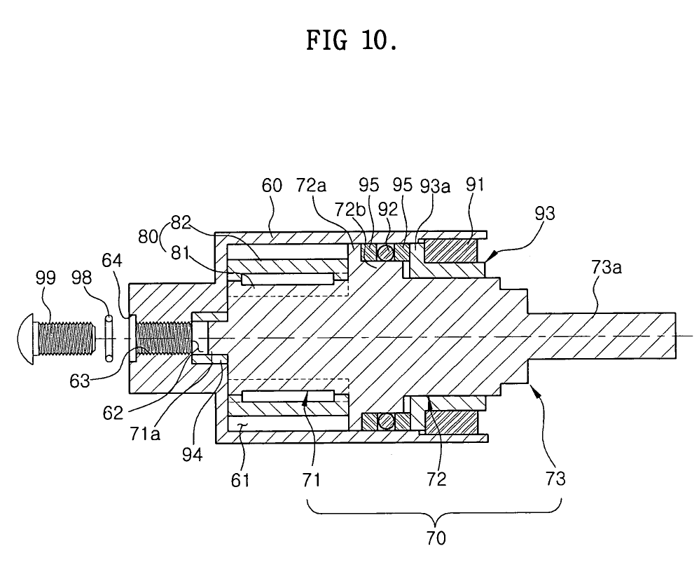

As shown in FIGS. 9 and 10, the damper, which is arranged in the second receiving chamber 32 of the housing 30, includes a damping case 60 defined therein with a fluid chamber 61 to receive a fluid having a certain viscosity such as silicon oil, a damping shaft 70 rotatably fitted, at one end thereof, in the damping case 60, and coupled, at the other end thereof, with the second hinge shaft 20, such that the damping shaft 70 is rotatable together with the second hinge shaft 20. Further, a pair of vanes 80 are arranged on a peripheral surface of the damping shaft 70, such that the vanes 80 are rotatable together with the damping shaft 70 within the fluid chamber 61. Although the damper includes two vanes 80 in the non-limiting illustrated case, a single vane or three or more vanes may be provided. Each vane 80 includes a first vane body 81 formed on the peripheral surface of the damping shaft 70, integrally with the damping shaft 70, and a second body 82 arranged between an inner peripheral surface of the damping case 60 and the first vane body 81, and coupled to the first vane body 81.

In accordance with the above-described structure of the damper, rotational resistance is generated from the vanes 80 when the vanes 80 rotate in the fluid chamber 61. The rotational resistance is transmitted to the damping shaft 70, and thus, to the second hinge shaft 20 coupled to the damping shaft 70, so that the rotating speed of the door 3, which is rotated by the hinge device 5, is reduced, thereby causing the door 3 to be smoothly closed.

The structure of the damper will be described in more detail. The damping case 60 has a cylindrical shape opened at one end thereof. The damping shaft 70 has first and second insert sections 71 and 72 inserted into the damping case 60 through the opened end of the damping case 60, and an extension 73 extending outwardly beyond the damping case 60. The first insert section 71 carries the vanes 80, and is arranged in the fluid chamber 61 so that the vanes 80 are arranged in the fluid chamber 61. The first insert section 71 has an end supported by an inner end surface of the damping case 60 opposite to the opened end of the damping case 60. The second insert section 72 is arranged between the first insert section 71 and the extension 73. A diameter-reduced axial support 71a extends from the end of the first insert section 71. A fitting groove 62 is formed at the inner end surface of the damping case 60, opposite to the opened end of the damping case 60, such that the axial support 71a is axially fitted in the fitting groove 62.

In order to prevent the fluid in the fluid chamber 61 from being outwardly leaked from the damping case 60 through the opened end of the damping case 60, the second insert section 72 is provided, at a portion thereof adjacent to the first insert section 71, with a first seal portion 72a having an increased diameter such that the first seal portion 72a comes into contact with the inner peripheral surface of the damping case 60. An annular cover 91 is fitted between the inner peripheral surface of the damping case 60 and the peripheral surface of the second insert section 72 at the side of the opened end of the damping case 60, so as to close the opened end of the damping case 60. An annular first sealing member 92, which is made of a rubber material, is arranged between the peripheral surface of the second insert section 72, between the first seal portion 72a, and the cover 91.

A first axial support bush 93 is fitted between the inner peripheral surface of the cover 91 and the peripheral surface of the second insert section 72. A second axial support bush 94 is fitted between the outer peripheral surface of the axial support portion 71a and the inner peripheral surface of the fitting groove 62. The first and second axial support bushes 93 and 94 support the damping shaft 70 such that the damping shaft 70 is rotatable in the damping case 60. A seal fitting portion 72b is formed at the second insert section 72. The seal fitting portion 72b extends axially from an end of the first seal portion 72a, facing the opened end of the damping case 60, to a certain length toward the opened end of the damping case 60. The seal fitting portion 72b has a diameter smaller than the diameter of the first seal portion 72a, but larger than the diameter of the second insert section 72 at the side of the cover 91. A second seal portion 93a extends radially from an end of the first axial support bush 93 opposite to the opened end of the damping case 60, between the cover 91 and the seal fitting portion 72b, such that the second seal portion 93a comes into contact with the inner peripheral surface of the damping case 60. The opened end of the damping case 60 is radially inwardly bent to engage with the cover 91 through a cocking process, and thus, to support the cover 91. Thus, the damping shaft 70 is fixed in the damping case 60. As the cover 91 is supported by the bent end of the damping case 60, in accordance with the engagement therebetween, the first axial support bush 93 is engaged with the cover 91 via the second seal portion 93a. Also, the seal fitting portion 72b is engaged with the second seal portion 93a. Accordingly, the damping shaft 70 is fixed in the damping case 60. In order to generate an enhanced force to seal the fluid chamber 61, the first sealing member 92 must be squeezed and elastically deformed between the first and second sealing portions 72a and 93a when the damping shaft 70 is fixed in the damping case 60. To this end, pressing washers 95 are fitted around the seal fitting portion 72b at opposite sides of the first sealing member 92. The pressing washers 95 are pressed by the first and second seal portions 72a and 93a during the procedure of mounting the damping shaft 70, so that the pressing washers 95 elastically deform the first sealing member 92. For the elastic deformation of the first sealing member 92, the sum of the thickness of the first sealing member 92, in a non-deformed state, and the thicknesses of the pressing washers 95, is larger than the length of the seal fitting portion 72b.

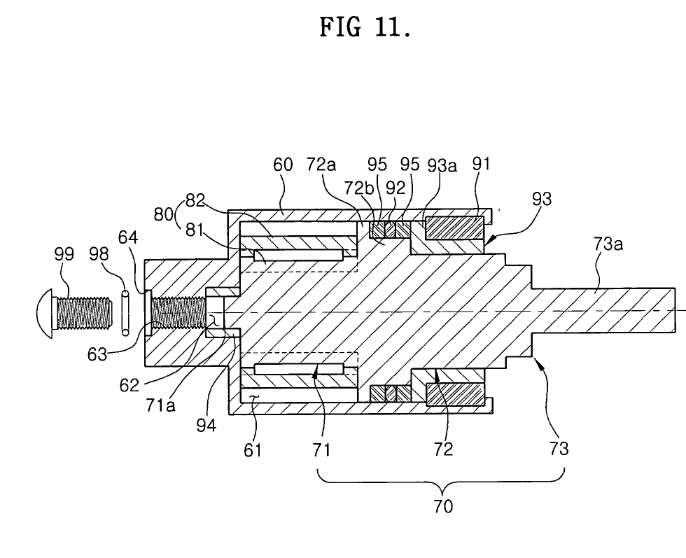

When the opened end of the damping case 60 is radially inwardly bent under the condition in which the first sealing member 92 and pressing washers 95 are fitted around the seal fitting portion 72b, such that the pressing washers 95 are arranged at opposite sides of the first sealing member 92, as shown in FIG. 11, the second seal portion 93a is pressed onto the seal fitting portion 72b, thereby causing the pressing washers 95 to be pressed by the first and second seal portions 72a and 93a. As a result, the first sealing member 92 is elastically deformed into an oval shape so that the first sealing member 92 comes into close contact with the inner peripheral surface of the damping case 60 and the peripheral surface of the seal fitting portion 72b. Thus, the force to seal the fluid chamber 61 is enhanced.

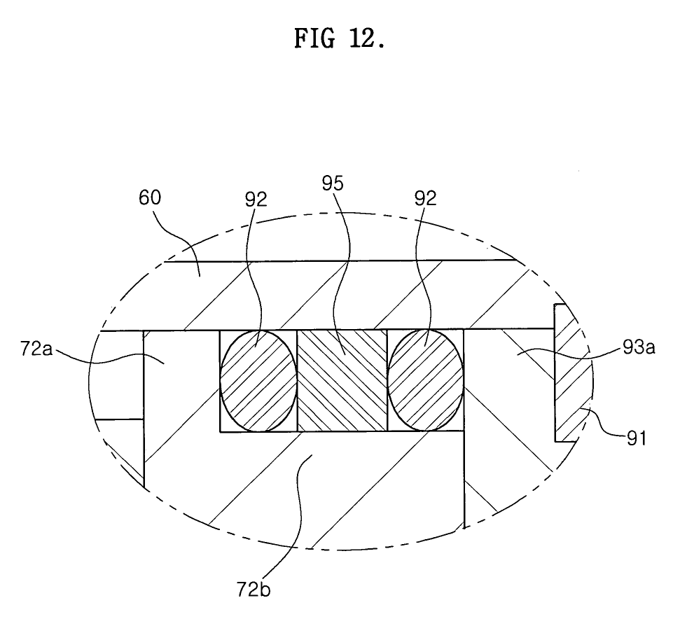

Although one first sealing member 92 and two pressing washers 95 are used in the non-limiting illustrated case, a plurality of first sealing members 92, for example, two first sealing members 92, may be used such that one pressing washer 95 is interposed between the first sealing members 92, as shown in FIG. 12.

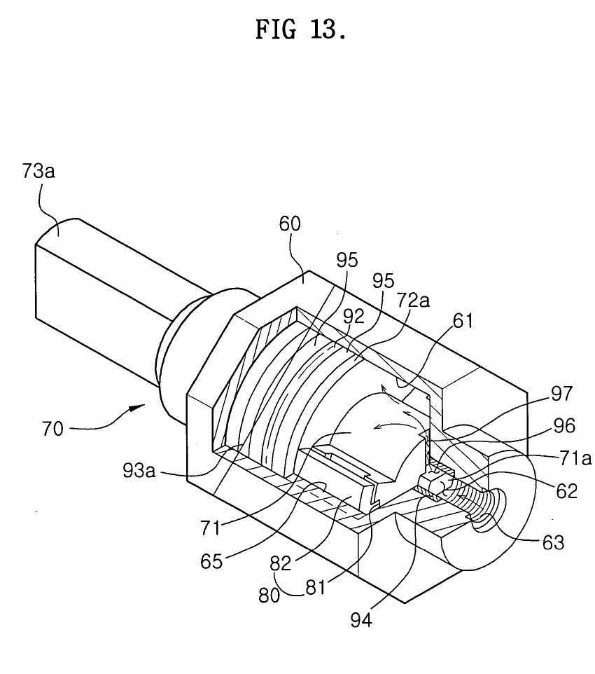

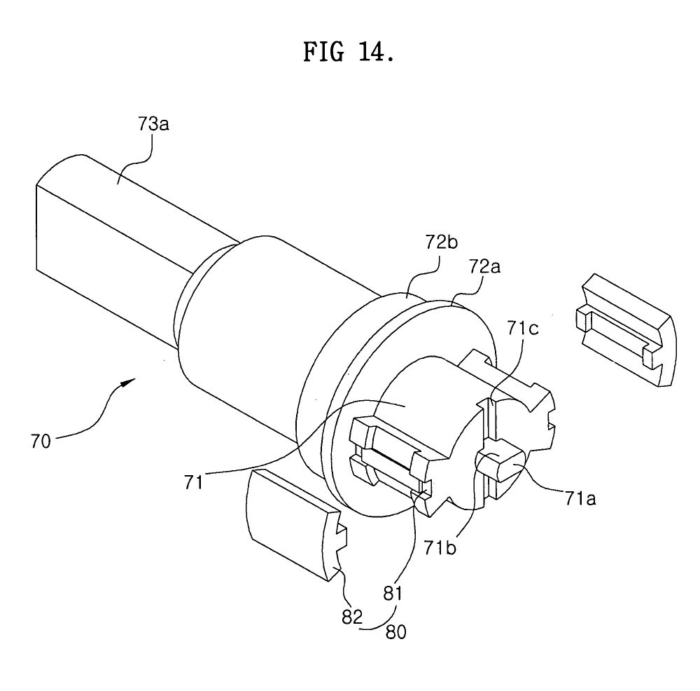

Again referring to FIG. 11, a fluid injection port 63 is formed through a portion of the damping case 60 at the side of the fitting groove 62, in which the axial support 71a is fitted, such that the fluid injection port 63 communicates with the fitting groove 62, in order to inject a fluid into the fluid chamber 61 in a state in which the opened end of the damping case 60 is closed in accordance with the fixing of the damping shaft 70 in the damping case 60. First and second communication holes 96 and 97 are also formed in the damping case 60 in order to communicate the fluid injection port 63 with the fluid chamber 60, and thus, to allow the fluid injected into the fluid injection port 63 to be supplied into the fluid chamber 60, as shown in FIGS. 13 and 14. The first communication hole 96 is formed between the axial support 71a and the second axial support bush 94, and the second communication hole 97 is formed between the inner end surface of the damping case 60 and the end surface of the first insert section 71 around the axial support 71a. In order to form the first communication hole 96, a cut-out 71b is formed on a portion of the peripheral surface of the axial support 71a, such that the cut-out 71b extends in an extension direction of the axial support 71a. Also, in order to form the second communication hole 97, a communication groove 71c is formed at the inner end surface of the first insert section 71 around the axial support 71a such that the communication groove 71c extends radially from the cut-out 71b.

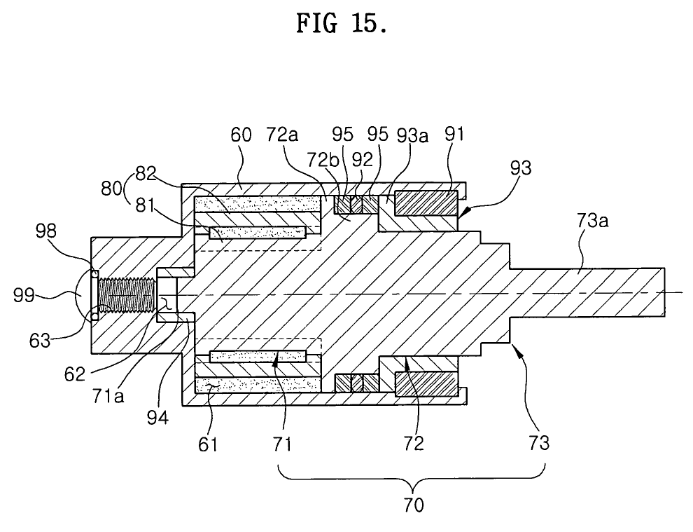

Referring to FIGS. 11 and 15, the fluid injection port 63 is closable by a screw 99 threadedly fastened to the fluid injection port 63 under the condition in which a second sealing member 98 is interposed between the fluid injection port 63 and the screw 99. For the fastening of the screw 99, female threads are formed on the inner surface of the fluid injection port 63. A seat groove 64 is formed at a portion of the damping case 60 around an inlet of the fluid injection port 63, so as to seat the second sealing member 98 in the seat groove 64. When the screw 99 is threadedly fastened to the fluid injection port 63, the second sealing member 98 is pressed into the seat groove 64 by an inner end of the screw 99. The fluid injection port 63 may be formed at a portion of the damping case 60 at the side of the fluid chamber 61 other than the side of the fitting groove 62.

Again referring to FIG. 9, the extension 73 of the damping shaft 70 is fitted in the second hinge shaft 20, so as to cause the damping shaft 70 to be operatively connected to the second hinge shaft 20, and thus, to be rotated together with the second hinge shaft 20. To this end, a fitting groove 22 is formed at an outer end of the second hinge shaft 20 extending into the second receiving space 32. Also, a fitting protrusion 73a is formed at an outer end of the extension 73 of the damping shaft 70, such that the fitting protrusion 73a is fittable in the fitting groove 22.

A spring 100 may be arranged in the second receiving space 32 of the damping case 60 to elastically force the damping case 60 to move toward the second hinge shaft 20, and thus, to cause the fitting protrusion 73a to be tightly fitted in the fitting groove 22. Where the spring 100 is used, it is preferred that a second inner support 32a be provided in the second receiving space 32 to support an end of the spring 100 opposite to the damping case 60, and thus, to stably support the spring 100 in the second receiving space 32. A support rim 23 is formed on the second hinge shaft 20 such that the support rim 23 comes into contact with the inner surface of the cover 34 around the shaft fitting hole 34a, thereby causing the second hinge shaft 20 is supported by the cover 34, as in the first hinge shaft 10.

Although not shown, the damping shaft 70 may be integral with the second hinge shaft 20. In this case, the process to couple the damping shaft 70 to the second hinge shaft 20 is dispensed with. Accordingly, the number of steps of assembling the hinge device 5 is reduced.

Meanwhile, the damping case 60 must be prevented from rotating within the housing 30 during the rotation of the damping shaft 70. To this end, the damping case 60 has a polygonal cross-sectional shape. Also, the inner peripheral surface of the housing body 33 of the housing 30 at the side of the second receiving space 32, in which the damping case 60 is received, also has a shape corresponding to the cross-sectional shape of the damping case 60, such that the outer peripheral surface of the damping case 60 is in close contact with the inner peripheral surface of the housing body 33.

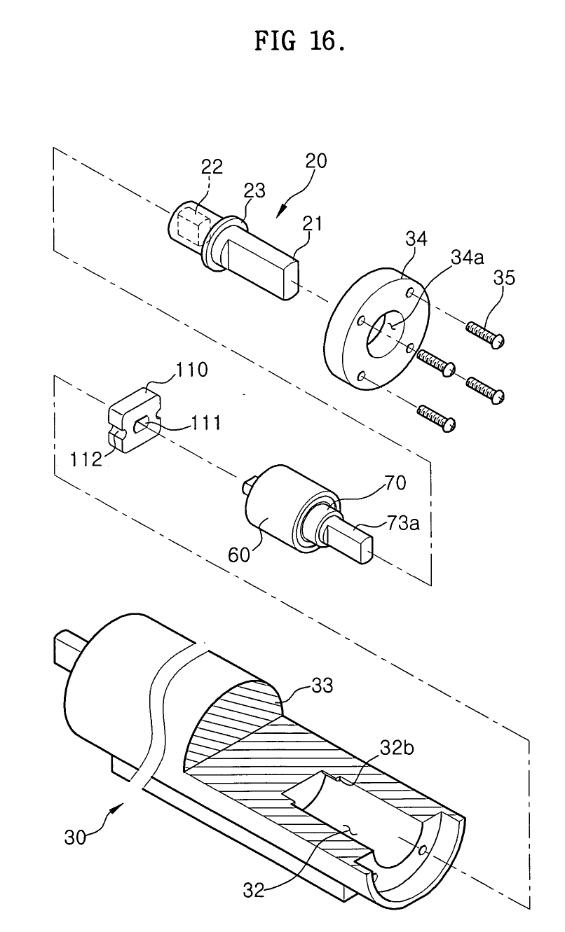

In place of such a rotation preventing structure, the damping case 60 may use a separate rotation preventing member 110 to prevent the damping case 60 from rotating in the housing 30, as shown in FIG. 16.

The rotation preventing member 110 has a central rotating preventing hole 111, in which the portion of the damping case 60, where the fluid injection port 63 is formed, is fitted without being allowed to rotate, and rotation preventing grooves 112 respectively formed at opposite lateral ends of the rotating preventing member 110. Also, rotation preventing protrusions 32b are formed at the inner peripheral surface of the housing body 33 at the side of the second receiving space 32 such that the rotation preventing protrusions 32b are engagable with the rotating preventing grooves 112, respectively, to prevent the rotating preventing member 110 from rotating. Accordingly, when the damping case 60 is coupled with the rotation preventing member 110 under the condition in which the rotating preventing grooves 112 of the rotation preventing member 110 are engaged with the rotation preventing protrusions 32b of the housing body 33, the damping case 60 is prevented from rotating. In this case, it is possible to surely prevent the damping case 60 from rotating, even when the damping case 60 has a cylindrical cross-sectional shape.

The damper may be configured to generate an increased resistance to the rotation of the second hinge shaft 20 at a position of the door 3 approximate to a completely closed position of the door 3, and thus, to greatly reduce impact caused by the weight of the door 3.

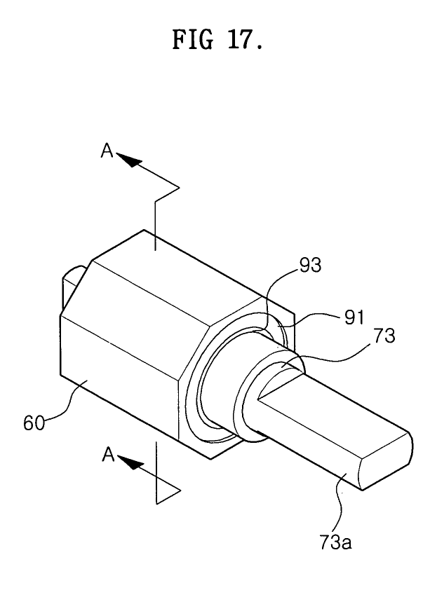

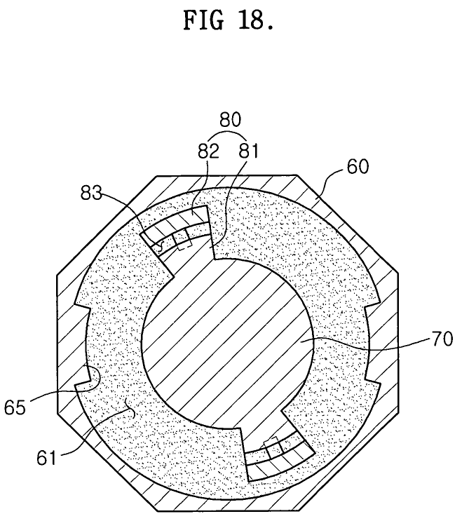

To this end, a fluid passage 83 having a desired size is formed at each vane 80 between the first and second vane bodies 81 and 82, as shown in FIGS. 17 to 19. Also, a damping boosting portion 65 is provided at a portion of the inner peripheral surface of the damping case 60 at the side of the fluid chamber 61, which faces an associated one of the vanes 80 when the door 3 reaches approximately its completely closed position. The damping boosting portion 65 reduces the gap defined between the inner peripheral surface of the damping case 60 and the associated vane 80 at the inner peripheral surface portion of the damping case 60 where the damping boosting portion 65 is arranged, as compared to the gap at other inner peripheral surface portions of the damping case 60. In the illustrated case, the damping boosting portion 65 is formed, integrally with the damping case 60, in the form of a protrusion extending radially inwardly from the inner peripheral surface of the damping case 60.

Accordingly, when each vane 80 passes through a portion of the fluid chamber 61 corresponding to a region other than a region where the associated damping boosting portion 65 is arranged, during rotation of the vane 80, the viscous fluid in the fluid chamber 61 flows through the large gap defined between the vane 80 and the damping case 60 and through the fluid passage 83, so that the rotational resistance applied to the damping shaft 70 is more or less low. On the other hand, when each vane 80 passes through a portion of the fluid chamber 61 corresponding to the region where the associated damping boosting portion 65 is arranged, during rotation of the vane 80, the viscous fluid in the fluid chamber 61 flows through the reduced gap defined between the vane 80 and the damping case 60 and through the fluid passage 83, so that the rotational resistance applied to the damping shaft 70 is relatively high. Thus, a high rotational resistance is applied to the second hinge shaft 20 when the door 3 reaches approximately the completely closed position thereof, so that the door 3 can be smoothly closed without generating any impact.

Each damping boosting portion 65 may extend to a large length to come into close contact with the associated vane 80 so that there is little or no gap defined between the damping boosting portion 65 and the vane 80. In this case, the viscous fluid in the fluid chamber 61 can flow only through the fluid passage 83 of each vane 80 rotating in the fluid chamber 61 when the vane 80 passes through the region where the associated damping boosting portion 65 is arranged. In order to prevent each vane 80 and each damping boosting portion 65 from being worn in this case, it is preferred that the second body 82 of each vane 80 be made of an elastic material. For reference, even when the damping boosting portions 65 are dispensed with, the damper can perform a desired damping function in accordance with operation of the vanes 80.

As described above, the hinge device 5, which includes the hinge shafts 10 and 20 arranged at opposite sides of the hinge device 5, has the form of a single unit. Accordingly, the hinge device 5 has a simple configuration. Also, the hinge device 5 is configured such that the closing speed of the door 3 is reduced by the damper when the door 3 reaches approximately the completely closed position thereof. Accordingly, the door 3 can be smoothly closed without generating impact.

Hereinafter, operation of the hinge device having the above-described configuration consistent with the present invention will be described.

When the user opens or closes the door 3, the first and second hinge shafts 10 and 20 connected to the door 3 are rotated together with the door 3. The opening and closing of the door 3 is easily carried out by virtue of a rotating force applied to the first hinge shaft 10 by the driver.

This operation will be described in detail. When the first hinge shaft 10 rotates, the first cam 13 provided at the cam shaft section 12 of the first hinge shaft 10 is rotated. During this rotation, the movable member 40 is always forced to move toward the first cam 13 by virtue of the elasticity of the spring 50, so that the second cam 43 is in contact with the first cam 13. Accordingly, the second cam 43 of the movable member 40 presses the first cam 13 of the first hinge shaft 10 while moving forwardly or backwardly in the axial direction of the first hinge shaft 10 during the rotation of the first hinge shaft 10 in the opening or closing direction of the door 3. In accordance with the pressing operation caused by the elasticity of the spring 50, a frictional force is generated between the first and second cams. The frictional force has an appropriate relation with the weight of the door 3 in accordance with an opening angle of the door 5, so that the door 3 can be easily opened and closed.

This will be described in more detail. When the door 3 of the storage container is positioned in an opening range shown in FIG. 2, as the door 3 is opened through a predetermined angle or more, the opening guide surface 44a of the second cam 43 and the opening guide surface 15a of the first cam 13 are in contact with each other. In this state, the second cam 43 of the movable member 40 presses the first cam 13 while moving toward the first cam 13, thereby generating a force causing the first cam 13 to rotate in the opening direction of the door 3. As a result, the door 3 can be easily opened. When the elasticity of the spring 50 is appropriately adjusted to approximately equalize the rotating force of the first hinge shaft 10 in the opening direction of the door 3 and the weight of the door 3, the door 3 can be maintained in a stopped state in the opening range.

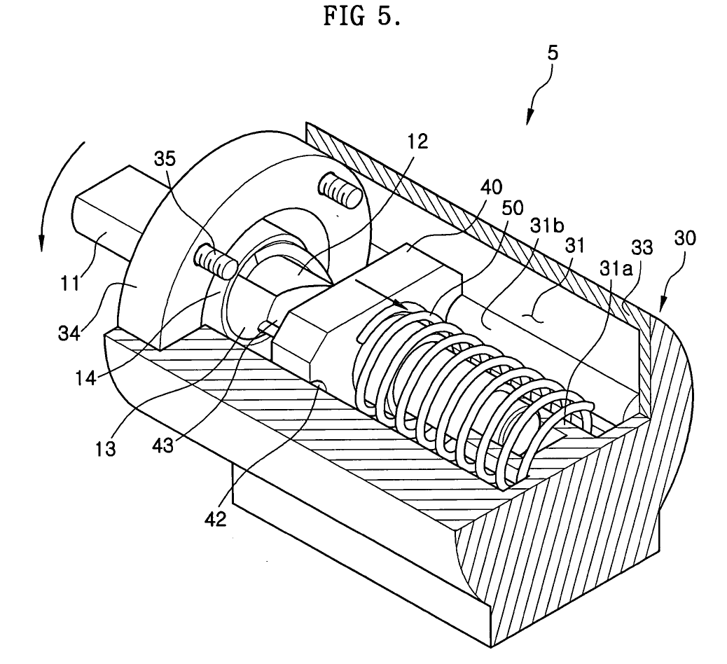

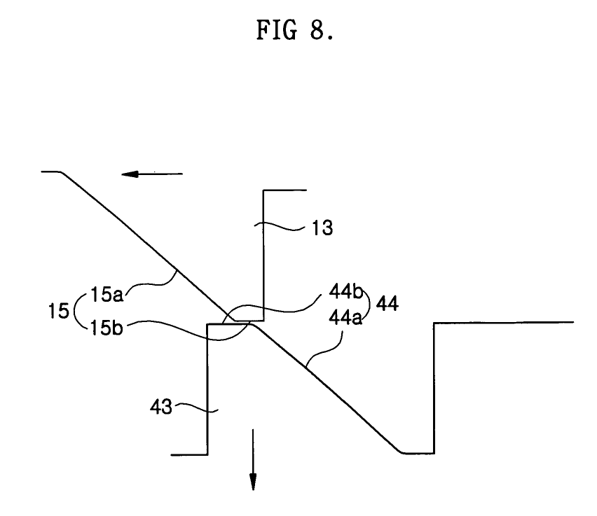

On the other hand, when the door 3 is positioned in a closing range shown in FIG. 2 as the opening angle of the door 3 is less than the predetermined angle, the closing guide surface 44b of the second cam 43 is in contact with the closing guide surface 15b of the first cam 13, as shown in FIGS. 5 and 8. In this state, accordingly, the elasticity of the spring 50 does not influence the rotation of the first hinge shaft 10. As a result, the first hinge shaft 10 is rotated in the closing range by virtue of the weight of the door 3, so that the door 3 hinges automatically in the closing direction, and thus, is automatically closed.

The rotational resistance applied to the second hinge shaft 20 by the damper increases when the door 3 reaches approximately its completely closed position. Accordingly, the door 3 is smoothly closed.

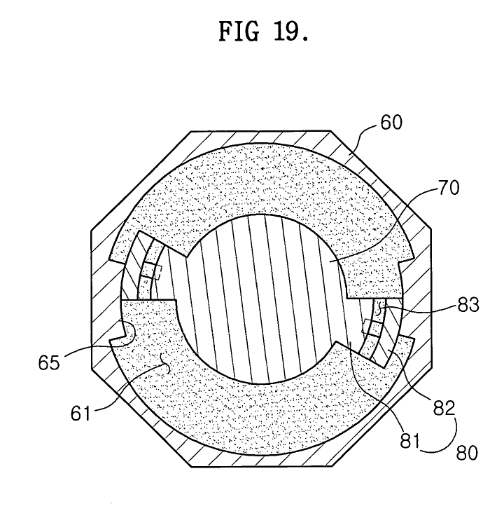

This operation will be described in detail. A rotational resistance is generated by the vanes 80 rotating in the fluid chamber 61 during the hinging operation of the door 3. The rotational resistance is transmitted to the damping shaft 70, and thus, to the second hinge shaft 20 coupled to the damping shaft 70, thereby reducing the rotating speed of the door 3. When the door 3 reaches approximately its completely closed position, the viscous fluid in the fluid chamber 61 flows through only the fluid passages 83 of the vanes 80, which pass through respective portions of the fluid chamber 61 corresponding to the regions where the damping boosting portions 65 are arranged, during the rotation of the vanes 80, as shown in FIG. 19. As a result, the rotational resistance generated by the vanes 80 and transmitted to the second hinge shaft 20 increases greatly. Accordingly, the door 3 is more smoothly closed without generating impact.

When each vane 80 passes through a portion of the fluid chamber 61 corresponding to a region other than the region where the associated damping boosting portion 65 is arranged, during rotation of the vane 80, the viscous fluid in the fluid chamber 61 flows not only through the fluid passage 83 of the vane 80, but also through the gap defined between the vane 80 and the damping case 60. As a result, the rotational resistance applied to the second hinge shaft 20 and door 3 is relatively low. Accordingly, the door 3 can hinge more rapidly.

As apparent from the above description, the storage container hinge device consistent with the present invention has a configuration simpler than those of conventional cases because the hinge couplers of the hinge device are combined into a single unit. Accordingly, it is possible to easily achieve the process of assembling the hinge device, and to smoothly close the door in accordance with the damping operation of the damper, and thus, to prevent impact from being generated when the door is closed.

Although exemplary, non-limiting embodiments of the present general inventive concept have been shown and described, it will be appreciated by those skilled in the art that changes may be made in these embodiments without departing from the principles and spirit of the invention, the scope of which is defined in the appended claims and their equivalents.

1. A hinge device for a storage container adapted to hingably connect a container body of the storage container and a door of the storage container, comprising:
a housing fixed to one of the container body and the door;
a first hinge shaft and a second hinge shaft rotatably coupled to the housing at opposite sides of the housing, respectively, each of the first and second hinge shafts having one end extending into the housing, and the other end extending outwardly beyond the housing and fixedly coupled to the other one of the container body and the door;
a cam hinge part comprising a cam shaft section provided at a portion of the first hinge shaft arranged in the housing to form a first cam, a movable member formed with a second cam arranged to face the first cam, and an elastic member to press the movable member; and
a damper provided at the second hinge shaft to increase a rotational resistance of the door.

2. The hinge device according to claim 1, wherein the damper comprises:
a damping case, in which a fluid chamber to contain a predetermined viscous fluid is defined;
a damping shaft inserted into the damping case; and
at least one vane provided at a peripheral surface of the damping shaft to rotate together with the damping shaft, and arranged in the fluid chamber.

3. The hinge device according to claim 2, wherein the vane has a fluid passage having a predetermined size.

4. The hinge device according to claim 1, wherein the damper increases the rotational resistance of the door when the door reaches approximately a position where the door is completely closed.

5. The hinge device according to claim 3, wherein the damper further comprises:
a damping boosting portion provided at a portion of an inner peripheral surface of the damping case at the side of the fluid chamber, which faces the vane when the door reaches approximately a position where the door is completely closed, the damping boosting portion reducing a gap defined between the inner peripheral surface of the damping case and the vane when the door reaches approximately the position where the door is completely closed.

6. The hinge device according to claim 5, wherein the damping boosting portion comes into close contact with the vane when the door reaches approximately the position where the door is completely closed.

7. The hinge device according to claim 5, wherein the damping boosting portion is radially inwardly protruded from the inner peripheral surface of the damping case in the form of a protrusion.

8. The hinge device according to claim 2, wherein the vane comprises:
a first body provided at the peripheral surface of the damping shaft, integrally with the damping shaft; and
a second body arranged between the inner peripheral surface of the damping case and the first body, and coupled to the first body, the second body being made of an elastic material.

9. The hinge device according to any one of claims 3, 4, and 5, wherein the damping shaft is integrated with the second hinge shaft.

10. The hinge device according to any one of claims 3, 4, and 5, wherein the damping shaft is coupled to the second hinge shaft.

11. The hinge device according to claim 10, wherein the damper further comprises:
a spring to force the damping case to move toward the second hinge shaft.

12. The hinge device according to claim 2, wherein:
the damping shaft includes an insert section inserted into the damping case, and an extension extending outwardly beyond the damping case;
the damping case has an opening formed at one end of the damping case to allow the insert section of the damping shaft to be inserted into the damping case; and
the insert section of the damping shaft has a portion arranged in the fluid chamber to install the vane on the insert section portion.

13. The hinge device according to claim 12, wherein:
the insert section includes a first insert section portion arranged in the fluid chamber and provided with an end axially supported by an inner end surface of the damping case opposite to the opening, and a second insert section portion arranged between the extension and the first insert section portion; and
the damping shaft further includes a first seal portion extending radially outwardly from the second insert section portion at a position adjacent to the first insert section portion, such that the first seal portion comes into contact with the inner peripheral surface of the damping case to prevent the fluid in the fluid chamber from leaking through the opening.

14. The hinge device according to claim 13, wherein the damper further comprises:
an annular cover fitted between the inner peripheral surface of the damping case and a peripheral surface of the second insert section portion at the side of the opening, to close the opening;
at least one first sealing member fitted around the peripheral surface of the second insert section portion between the first seal portion and the cover;
a seal fitting portion arranged at the second insert section portion extending axially from an end of the first seal portion facing the opening toward the opening, the seal fitting portion having a diameter smaller than a diameter of the first seal portion, but larger than a diameter of the second insert section portion at the side of the cover;
a first axial support bush fitted between the cover and the second insert section portion to rotatably support the damping shaft;
a second seal portion extending radially from an end of the first axial support bush between the cover and the seal fitting portion, such that the second seal portion comes into contact with the inner peripheral surface of the damping case; and
at least one pressing washer fitted around the seal fitting portion, wherein an end of the damping case, defining the opening, is radially inwardly bent to engage with the cover, and thus, to support the cover, so that the damping shaft is fixed in the damping case,
wherein the second seal portion comes into contact with an end of the seal fitting portion facing the opening when the damping shaft is fixed in the damping case,
wherein the first sealing member is pressed and elastically deformed between the first seal portion and the second seal portion when the damping shaft is fixed in the damping case,
wherein the at least one pressing washer is pressed between the first seal portion and the second seal portion to elastically deform the first sealing member.

15. The hinge device according to claim 14, wherein a thickness sum of the at least one first sealing member and the at least one pressing washer before the at least one first sealing member is elastically deformed is larger than a length of the seal fitting portion.

16. The hinge device according to claim 14, wherein the at least one pressing washer comprises a pair of pressing washers respectively arranged at opposite sides of the first sealing member.

17. The hinge device according to claim 13, wherein the damper further comprises:
a diameter-reduced axial support protruded from an end of the first insert section portion opposite to the opening;
a fitting groove formed at an inner end surface of the damping case opposite to the opening, to receive the axial support; and
a second axial support bush fitted between the axial support and the fitting groove.

18. The hinge device according to claim 14, wherein the damper further comprises:
a fluid injection port formed through a portion of the damping case at the side of the fluid chamber, to inject the fluid into the fluid chamber, the fluid injection port being closed by a screw fastened to the fluid injection port in a state in which a second sealing member is interposed between the fluid injection port and the screw.

19. The hinge device according to claim 18, wherein the damper further comprises:
a diameter-reduced axial support protruded from an end of the first insert section portion opposite to the opening;
a fitting groove formed at an inner end surface of the damping case opposite to the opening, to receive the diameter-reduced axial support, the fitting groove communicating with the fluid injection port;
a second axial support bush fitted between the diameter-reduced axial support and the fitting groove; and
a first communication hole and a second communication hole respectively formed between the diameter-reduced axial support and the second axial support bush, and between the inner end surface of the damping case opposite to the opening and an end surface of the insert section around the diameter-reduced axial support, to communicate the fluid injection port with the fluid chamber.

20. The hinge device according to claim 2, wherein the damping case is arranged in the housing such that the damping case is prevented from rotating.

21. The hinge device according to claim 1, wherein:
the first and second cams have cam surfaces having a valley-and-mountain structure such that the cam surfaces are engaged with each other, respectively; and
each of the cam surfaces has an inclined opening guide surface and a substantially horizontal closing guide surface.

22. The hinge device according to claim 1, wherein the housing comprises:
a housing body having opened opposite ends to receive the cam hinge part and the damper, respectively; and
a pair of covers respectively fitted in the opened opposite ends of the housing body, and centrally formed with shaft fitting holes, through which the first and second hinge shafts extend.

23. A storage container comprising a container body, in which an upwardly-opened storage compartment is defined, a door to open and close the storage compartment, and a hinge device to hingably connect the door and the container body, the hinge device comprises:
a housing fixed to one of the container body and the door;
a first hinge shaft rotatably coupled to one end of the housing, the first hinge shaft having one end extending into the housing, and the other end extending outwardly beyond the housing and fixedly coupled to the other one of the container body and the door;
a cam type driver arranged in the housing at the side of the first hinge shaft to apply, to the first hinge shaft, a rotating force to cause the door to be maintained in an opened state or to be closed in accordance with an opening angle of the door; and
a damper to increase a rotational resistance of the door.

24. The storage container according to claim 23, wherein:
the driver comprises a first cam provided on a peripheral surface of the first hinge shaft, a movable member formed with a second cam arranged to face the first cam, and an elastic member to press the movable member such that the second cam comes into contact with the first cam; and
the damper comprises a damping case, in which a fluid chamber to contain a predetermined viscous fluid is defined, a damping shaft inserted into the damping case, and at least one vane arranged in the fluid chamber of the damping case to restrain a rotation of the damping shaft.

25. The storage container according to claim 24, wherein:
the hinge device further comprises a second hinge shaft rotatably coupled to the other end of the housing;
the damper is arranged in the housing at the side of the second hinge shaft; and
the damping shaft is rotated together with the second hinge shaft.

26. The storage container according to claim 25, wherein the damper increases a rotational resistance of the second hinge shaft when the door reaches approximately a position where the door is completely closed.

27. The storage container according to claim 25, wherein the damper further comprises:
a fluid passage formed in the vane and having a predetermined size; and
a damping boosting portion provided at a portion of an inner peripheral surface of the damping case at the side of the fluid chamber, which faces the vane when the door reaches approximately a position where the door is completely closed, the damping boosting portion reducing a gap defined between the inner peripheral surface of the damping case and the vane when the door reaches approximately the position where the door is completely closed, to increase a rotational resistance of the second hinge shaft.

28. A hinge device for a storage container adapted to hingably connect a container body of the storage container and a door of the storage container, comprising:
a housing fixed to one of the container body and the door and having opened opposite ends; and
hinge units having different operating structures respectively arranged at the opened opposite ends of the housing and fixed to the other one of the container body and the door.
